(19) United States
(12) Patent Application Publication
(10) Pub. No.: US 2026/0328315 A1
(43) Pub. Date: Oct. 22, 2026

(54) HOSE FOR HEATING A FLUID AND HOSE ARRANGEMENT

(71) Applicant: Eichenauer GmbH & Co. KG, Kandel (DE)

(72) Inventors: Philippe Leininger, Hagenau (FR); Manfred Stoll, Kandel (DE)

(21) Appl. No.: 18/994,493

(22) PCT Filed: Jul. 14, 2023
(86) PCT No.: PCT/EP2023/069687

§ 371 Date: Jan. 14, 2025

(30) Foreign Application Priority Data
Jul. 14, 2022 (DE) 10 2022 117 668.1

(51) Int. Cl. F16L 11/127; H05B 3/58

(52) U.S. Cl. CPC F16L 11/127; H05B 3/58; H05B 2203/02; H05B 2203/021; H05B 2214/02

(57) ABSTRACT

A hose for heating a fluid, which is conveyable through a cavity of the hose. The hose comprises a heating device that includes at least two electrodes. The at least two electrodes are configured to input electrical energy into an electrically-conductive plastic material of the heating device in a heating operation of the heating device. The heating device at least partially surrounds the cavity in a circumferential direction. At least the heating device has a contour in cross-section which is different from a rotationally symmetrical contour. Furthermore, the disclosure relates to a hose arrangement with a hose and with a connection device arranged at the hose.

### BACKGROUND

### Technical Field

The present disclosure relates to a hose for heating a fluid, which is conveyable through a cavity of the hose. Furthermore, the disclosure relates to a hose arrangement with a hose for heating a fluid and with a connection device arranged at the hose for delivering the fluid.

### Description of the Related Art

DE 20 2008 007 392 U1 describes a fluid line as it can be employed in motor vehicles for instance as a water line for the windshield wiper system. The fluid line is composed of a heating line with an electrical heating element, wherein the heating element is composed of an electrically conductive plastic material with embedded electrodes.

A further electrically-heatable media line with an electrically conductive plastic material is described in DE 10 2010 051 550 A1.

Furthermore, it can be provided to install heating wires in a hose for heating a fluid such as for instance a washing liquid for a windshield of a motor vehicle. Such a hose comprising heating wires can be used to input the washing liquid into a nozzle, which is not arranged at a free end of the hose, but spaced from the free end. In such a case, the assembly of the nozzle is often associated with increased effort because it can be required to separate the hose and thus also the heating wires in the area of the nozzle into two partial pieces. For example, this is the case if the nozzle is also to be heated by means of the heating wires. Such an increased assembly effort is disadvantageous.

In addition, in a hose heated by means of heating wires, it is laborious to design a heating power of the heating wires such that an undesirably severe heating of the hose does not occur in the operation of the heating wires. This is also disadvantageous.

### BRIEF SUMMARY AND GENERAL DESCRIPTION

A hose and a hose arrangement as described herein are improved with respect to a heating operation.

Advantageous configurations with convenient developments of the disclosure are specified in the claims and in the following description.

A hose according to the present disclosure for heating a fluid, which is conveyable through a cavity of the hose, comprises a heating device. The heating device includes at least two electrodes. The at least two electrodes are formed to input electrical energy into an electrically conductive plastic material of the heating device in a heating operation of the heating device. The heating device at least partially surrounds the cavity in a circumferential direction. At least the heating device has a contour in cross-section, which is different from a rotationally symmetrical contour.

In that the electrically conductive plastic material of the heating device is supplied with electrical energy via the at least two electrodes for heating the fluid or in the heating operation of the heating device, a high heating power can be achieved. Herein, the contour non-rotationally symmetrical in cross-section at least of the heating device is advantageous because the high heating power can thus be achieved in the heating operation of the heating device with a comparatively low amount of conductive plastic material. Therefore, the hose is improved with regard to the heating operation.

This in particular applies compared to a formation of the hose, in which the heating device or the hose including the heating device is formed round in cross-section. Thus, a higher heating power can be achieved with a comparatively low amount of electrically conductive plastic material than it would be the case with a heating device having a round contour in cross-section.

Due to the non-rotationally symmetrical contour of the heating device, in particular of the hose including the heating device, only comparatively little electrically conductive plastic material has to be arranged between two adjacent electrodes preferably having different electrical polarities. Nevertheless, a high heat emission occurs in the heating operation in this plastic material due to passing electrical current, which causes heating of the fluid. Namely, the electrically conductive plastic material has a higher electrical resistance than the electrodes.

Due to the non-rotationally symmetrical contour at least of the heating device, in particular of the hose including the heating device, by a suitable spatial distribution of the at least two electrodes, it can be particularly simply caused that the high heating power is provided by the heating device in the heating operation. With a hose of given length, the heating power can be correspondingly increased by reducing the distance between the electrodes and/or by using more than two electrodes. Both can be particularly well realized due to the contour non-rotationally symmetrical in cross-section at least of the heating device.

If an outer side of the hose is formed by the heating device, thus, the hose accordingly also has a contour or outer contour, which is different from the rotationally symmetrical contour. In analogous manner, a non-rotationally symmetrical outer contour of the hose can be caused in that the heating device is surrounded by a sheath or envelope, which has an at least substantially constant thickness. However, even with a non-continuously constant thickness of the sheath, the entire hose can have the outer contour non-rotationally symmetrical in cross-section, namely if the sheath itself has such a non-rotationally symmetrical outer contour.

To such a hose, which has the outer contour in cross-section, which is different from the rotationally symmetrical contour or outer contour, a nozzle or the like connection device can for example be attached in a desired radial orientation in reliable and simple manner. Due to the non-rotationally symmetrical outer contour of the hose, a rotation of the nozzle in relation to the hose can be avoided if the hose is engaged with a corresponding receptacle of the nozzle, because the nozzle or such a connection device for outputting or forwarding the fluid is then rotationally fixedly coupled to the hose. This is advantageous with regard to a simple assembly with low effort in attaching the at least one nozzle or the like connection device to the hose. In this case, the hose is also improved with respect to the assembly.

The contour at least of the heating device can for example have a circumferentially closed U-shape in cross-section or be polygonal in cross-section. By such shapes, the advantages associated with the contour non-rotationally symmetrical in cross-section at least of the heating device, in particular of the hose including the heating device, can be achieved to particular extent.

In particular, due to the non-rotationally symmetrical contour at least of the heating device, it can be provided that the at least two electrodes are not symmetrically or asymmetrically arranged in the electrically conductive plastic material. With three electrodes or more than three electrodes, which are arranged in the electrically conductive plastic material, different distances of the electrodes from each other can for example be present. And with exactly two electrodes arranged in the conductive plastic material, the two electrodes can have a first distance from each other in a first direction circumferential around the cavity, and a second distance, which is larger than the first distance, in a second direction, which is opposite to the first direction. In this manner, a very uniform distribution of the heat emitted by the heating device in the heating operation can be caused despite of the non-rotationally symmetrical contour at least of the heating device, in particular of the hose including the heating device.

Additionally or alternatively, the asymmetric arrangement of the at least two electrodes in the non-rotationally symmetrical contour at least of the heating device allows locally realizing a particularly high heating power in the heating operation, namely where a comparatively low distance between two adjacent electrodes having polarities deviating from each other is present.

In particular, by using more than two electrodes, it can be ensured that a comparatively low distance is present between two adjacent electrodes viewed in circumferential direction around the cavity. This is advantageous with regard to a high heating power in the heating operation of the heating device. Because a lower distance between the electrodes implies that a shorter path has to be traveled by the current through the electrically conductive plastic material from one electrode to the adjacent electrode in the heating operation than with a larger distance of the electrodes from each other, this is associated with a lower electrical resistance of the electrically conductive plastic material and accordingly with an increased heating power in the heating operation of the heating device.

Preferably, the electrically conductive plastic material of the heating device has a positive temperature coefficient (PTC). In this manner, an intrinsic safety of the heating device is ensured in the heating operation. Since the electrical resistance of the plastic material increases with increasing temperature of the plastic material, it can be avoided in the heating operation that the hose reaches an undesirably high operating temperature. In addition, a very fast heating of the fluid can advantageously be achieved since the low initial resistance of the PTC heating device implies a high initial power of the heating device.

In this manner, it can in particular be ensured that a temperature of the hose does not exceed about 110 °C in the heating operation of the heating device. Preferably, it is provided that the hose reaches a temperature of not more than about 70 °C in the heating operation of the heating device.

Preferably, at least the heating device has a contour rectangular in cross-section, wherein a respective electrode is arranged in four corner areas of the heating device. Such a hose with the heating device comprising the four electrodes in the four corner areas and therefore rectangular in cross-section, in particular the heating device substantially square in cross-section, provides a particularly high heating power with a particularly low employment of electrically conductive plastic material. In addition, particularly low distances from a respective electrode to the electrode adjacent in circumferential direction around the cavity can be ensured by such a geometry, which the electrical current has to travel through the electrically conductive plastic material in the heating operation. This is advantageous with regard to the high heating power.

In particular, with a polygonal contour at least of the heating device, in particular of the hose including the heating device, in which a respective electrode is arranged in the corner areas of the heating device, short distances from each of the electrodes to the respectively adjacent electrode can advantageously be realized. With an octagonal contour of the heating device, eight electrodes can thus be correspondingly embedded in the electrically conductive plastic material. This is advantageous with regard to the achievable heating power.

Providing a considerably greater number of electrodes in the electrically conductive plastic material in turn implies an increased effort with regard to the electrical connection of the electrodes and an increased effort for providing the electrodes themselves and embedding the electrodes in the plastic material. Therefore, it can be provided that the hose preferably does not comprise more than eight electrodes and in particular exactly the four electrodes arranged in the corner areas of the heating device.

The electrodes can have a round cross-sectional area. Thereby, the electrodes can be particularly simply provided with low effort.

Furthermore, it has proven to be advantageous if the electrodes are formed ribbon-shaped. Therein, a width of the respective ribbon-shaped electrode is preferably at least three times, further preferably at least five times, a thickness of the ribbon-shaped electrode because this is associated with a large contact surface of the respective electrode with the adjoining plastic material. Due to the lower electrical resistance resulting from it, this is advantageous for a high heating power.

The electrodes can be formed in the manner of braids, which comprise a plurality of wires or individual wires, in particular twisted with each other. Herein, silver-plated individual wires can in particular be employed, to cause a very high electrical conductivity of the electrodes. The formation of the electrodes as braids is advantageous with regard to the fact that the hose provided with the electrodes can be bent on the one hand and thus is flexibly formed, but still has a certain bending stiffness. This bending stiffness can be again increased by twisting the individual wires.

Preferably, the electrodes are arranged symmetrically in the plastic material with respect to at least one plane of symmetry, which includes a central axis of the hose. In this manner, a very uniform heating of the fluid flowing through the cavity in using the hose can be achieved in the heating operation. This in particular applies if the heating device completely surrounds the cavity in circumferential direction.

Preferably, the hose comprises at least one passage opening, via which the fluid is conveyable out of the cavity in lateral direction into an environment of the hose in the operation of the hose. In this manner, a fluid exit out of the hose can be achieved not only in an area of an end of the hose, but also in a hose section spaced from respective end areas of the hose. This can be advantageous if areas spaced from each other, for instance areas of the surface of a windshield of a motor vehicle or another surface of the motor vehicle to be cleaned, are to be supplied with the heated fluid in the operation of the hose.

For example, this is advantageous if the fluid is formed as a washing liquid for a windshield wiper system of the motor vehicle because in such a case, freezing of the fluid can be avoided by operating the heating device, even if the washing liquid contains only a low portion of or no anti-freezing agent at all. This is advantageous with regard to reliably cleaning a surface, in particular the surface of a windshield of the motor vehicle, due to the use of the heated fluid. Additionally or alternatively, the fluid can be formed as a washing liquid, which is provided in using the hose to clear or keep clear a field of vision or capturing area of at least one sensor and/or at least one lamp such as for instance a headlight of the motor vehicle from contaminations.

The cavity of the hose traversed by the fluid in the operation of the hose can in particular have a round cross-section. This is advantageous with regard to a low flow resistance in flowing through the cavity. However, geometries of the cavity deviating from an internal diameter with strictly round cross-section can also be provided, wherein a cross-section of the cavity free of corners is preferred to achieve the advantageously low flow resistance.

The cavity can be delimited by a lining of the hose towards the conductive plastic material, which is preferably formed of an electrically non-conductive material. Thus, an electrical insulation of the heating device with respect to the fluid is ensured. This is in particular advantageous if the fluid contains electrically conductive constituents. Moreover, a lining can be advantageous if the conductive plastic material does not have sufficient chemical resistance with respect to the fluid or ingredients of the fluid.

The at least one passage opening can for example be produced in the hose by punching and/or drilling and/or by melting the material of the hose for instance by means of a laser. Thus, in particular a precisely formed passage opening well capable of being traversed by the fluid can be provided with low effort. By the contour of the hose non-round in cross section, the hose can therein be positioned in a tool or a bracket oriented such that the passage opening can be generated sufficiently widely spaced from the electrodes in any case.

Advantageously, the hose can comprise two passage openings arranged aligned with each other, in particular arranged aligned with each other in radial direction, via which the fluid can be conveyed out of the cavity in lateral direction into the environment of the hose. Providing the two passage openings arranged aligned with each other has the advantage that remaining of residuals in particular of the plastic material in the cavity of the hose can be avoided in the production. This is advantageous with regard to a manufacture with low effort because such residuals do not have to be removed from the cavity in the production or manufacture of the hose. Furthermore, the two passage openings arranged aligned with each other can be particularly simply produced in one working step, in particular by punching and/or drilling and/or laser cutting.

Moreover, due to providing the two passage openings arranged aligned with each other, a lower cross-section of the respective passage opening capable of being traversed can be present than it would be the case for providing a certain volumetric flow of the fluid in providing only one passage opening in the hose. This is advantageous in particular with regard to the fact that a damage of the electrodes arranged in the plastic material can be particularly simply avoided in producing the passage openings due to the low size of the passage openings aligned with each other.

In order to convey a certain volumetric flow of the fluid out of the cavity in lateral direction into the environment of the hose, with two passage openings, a cross-section capable of being traversed only half as large is to be provided per passage opening than it would be the case in providing only one passage opening. In other words, the flow rate of the fluid per passage opening can be halved. And by providing the two small passage openings arranged aligned with each other, a damage of the electrodes in the course of production of the passage openings can be particularly largely avoided.

Preferably, at least one connection device formed for outputting the fluid is arranged at a hose section of the hose, which is spaced from respective end areas of the hose. Herein, the fluid can be introduced into the connection device via the at least one passage opening in the operation of the hose.

Thus, the heated fluid can be output from the hose section spaced from the end areas of the hose via the connection device. This is advantageous with regard to a flexible use of the fluid.

Furthermore, it is advantageous that this part of the fluid, which further flows through the cavity and is not introduced into the connection device via the at least one passage opening, additionally also causes heating of the connection device.

Since the hose section completely passes through the connection device, heat is additionally released into the connection device over a correspondingly large length area of the hose passed through the entire connection device in the heating operation of the heating device. This is advantageous for good heating of the connection device. A particularly extensive heating of the connection device in the heating operating of the heating device can in particular be achieved if the hose section is in heat conducting contact with the connection device. Thus, a very intensive heat transfer from the hose section or an outer side of the hose section to the connection device can be caused.

In particular, if the connection device comprises an outlet or an exit opening, an output of the heated fluid via this exit opening or this outlet can be advantageously achieved.

The connection device can be formed as a nozzle or the like output element, which is formed for outputting the fluid into the environment. By forming the connection device as a nozzle, the fluid exiting the cavity into the environment can be particularly specifically conveyed to a certain location of the surface to be supplied with the fluid. This is advantageous. The latter applies both if the exiting fluid is accelerated by the nozzle or such an output element and if such an influence of the exiting fluid does not occur by the connection device.

In particular, if the fluid flowing through the cavity of the hose is a washing liquid, the connection device can be formed as a connection of a wiper blade of a windshield wiper system, into which the fluid heated by means of the hose in the heating operation can be introduced. Additionally or alternatively, the connection device can be formed as a fluid distributor or the like.

In such configurations of the connection device too, it is advantageous that heating of the connection device occurs by means of the fluid flowing through the cavity, heated in the heating operation of the heating device, and especially by operating the heating device.

Preferably, the connection device, in particular the nozzle formed for outputting the fluid into the environment, comprises a receptacle with an inner contour, which corresponds to a non-rotationally symmetrical outer contour of the hose. Thus, the connection device, in particular the nozzle, can be very simply positioned in the hose section of the hose, which is spaced from the respective end areas of the hose, by inserting the hose into the receptacle. This is conducive to a simple assembly in the attachment of the connection device, in particular of the nozzle, to the hose. Advantageously, a heat transfer from the hose section passed through the receptacle to an interior of the connection device occurs in the heating operation of the heating device. Thereby, the hose or heating hose also heats at least partial areas of the connection device, in particular of the nozzle, with its heated surface. A particularly good heat transfer can be achieved if the connection device, in particular the nozzle, comprises a heat conducting body, for example a metallic heat conducting body, in the area of the receptacle.

If the connection device, in particular the nozzle, is for example two-part formed, thus, the two parts of the connection device, in particular of the nozzle, can be connected to each other in the hose section comprising the at least one passage opening, such that the connection device, in particular the nozzle, is positioned at the hose section as desired. With such an assembly too, it is advantageous if the connection device, in particular the nozzle, comprises the receptacle with the inner contour, which corresponds to the outer contour of the hose, which is different from a rotationally symmetrical contour. Thus, a positioning of the connection device or nozzle in the hose section in particular secured against rotation can be achieved.

The connection device in particular formed as a nozzle can comprise an annular channel, via which the fluid can be introduced from the two passage openings arranged aligned with each other into the connection device, in particular into the nozzle. Thus, a particularly unimpeded exit of the fluid from the connection device or nozzle can be achieved in the operation of the hose.

Preferably, the connection device, in particular the nozzle, is fluid-tightly connected to the hose section. In this manner, an undesired exit of fluid into the environment is prevented. This causes an efficient use of the fluid.

The fluid-tight connection of the connection device, in particular of the nozzle, to the hose section can be achieved by glueing and/or welding, in particular laser welding, or the like. Additionally or alternatively, at least one sealing element, in particular in the form of at least one O-Ring, can cause a fluid-tight seal of the connection device, in particular of the nozzle, with respect to the hose. Additionally or alternatively, subsequent to attachment of the connection device, in particular of the nozzle, to the hose section, a sealing material can additionally be arranged from the outside, where the hose adjoins to an outer wall of the connection device, in particular of the nozzle. For example, such a sealing can be performed by means of a grout and/or an adhesive or the like, with which the outer wall of the connection device, in particular of the nozzle, and the area of the hose adjoining to the outer wall are supplied. In this manner, a good fixing of the connection device or nozzle in axial direction of the hose can additionally be ensured.

Preferably, the hose comprises at least one positioning element, by means of which the connection device, in particular the nozzle, is arranged at the hose section in a predetermined radial orientation and secured against rotation. Herein, the connection device, in particular formed as a nozzle, comprises a structural element corresponding to the positioning element. In this manner, it is ensured that the connection device, in particular the nozzle, is arranged at the hose section exactly with the desired radial orientation. The connection device, in particular the nozzle, can be attached to the hose only in an accurately predetermined orientation or alignment in the hose section due to providing the at least one positioning element.

For example, if the hose has an outer contour square in cross-section, which corresponds to a square inner contour of the receptacle of the connection device, in particular of the nozzle, thus, four mutually different radial orientations of the connection device, in particular of the nozzle, in relation to the hose are possible. In contrast, due to providing the at least one positioning element, the connection device, in particular the nozzle, can be attached to the hose only in exactly one radial orientation, namely in the predetermined radial orientation, in the hose section. This is advantageous with regard to an error-free and reliable assembly of the connection device, in particular of the nozzle, at the hose section.

In particular, the at least one positioning element can be used as a guide if the connection device, in particular the nozzle, is arranged in the hose section by pushing it onto the hose. This too is advantageous with regard to a simple assembly of the connection device, in particular of the nozzle. With such an assembly of the connection device, in particular of the nozzle, by pushing it onto the hose, the hose additionally does not have to be separated for the purpose of attachment of the connection device, in particular of the nozzle, in the hose section. Nevertheless, the heated fluid can be introduced into the connection device, in particular the nozzle, in the operation of the hose. Thus, heating of the connection device, in particular of the nozzle, can be achieved by means of the fluid.

The at least one positioning element can be provided by an indentation and/or bulge and/or chamfer. This can be technically particularly simply realized.

The indentation and/or bulge and/or chamfer can be formed at least in an envelope of the hose, wherein the envelope of the hose externally encompasses the heating device. Thereby, the positioning element can be provided in advantageous manner independently of the configuration of the heating device.

In addition, a protecting sheathing for the heating device is provided by the envelope in advantageous manner, which in particular offers a protection from impact of the heating device by corroding substances, for instance in the form of salts or the like, and/or by UV light and/or by other undesired influences. Furthermore, an electrical insulation of the heating device can be achieved by the envelope of the hose.

The envelope or sheathing can be formed with very low effort of a plastic such as for instance an ethylene-propylene-diene rubber (EPDM) and/or of a thermoplastic elastomer (TPE), in particular a thermoplastic elastomer containing styrene, thus a TPS material.

The envelope can have a thickness of up to about 0.6 mm, wherein a thickness in the order of magnitude of about 0.4 mm can in particular be provided. Thus, a good external protection of the heating device can be ensured with comparatively low material employment. Accordingly, the envelope causes a good environmental resistance of the hose.

Preferably, a connection device formed for outputting the fluid into the environment is arranged at a free end area of the hose. Thus, the fluid reaching the end area of the hose in the heating operation can be introduced into the connection device in heated state. This is advantageous, for instance to achieve also heating of the connection device.

In particular, the connection device can be formed as an end nozzle formed for outputting the fluid into the environment or the like output element. Thereby, the fluid can be applied to a surface to be supplied with the fluid for instance in the form of the windshield of the motor vehicle or the like via the end nozzle in the operation of the hose.

However, the connection device can also be formed as a component of a fluid carrying wiper blade, into which the fluid heated in the heating operation of the heating device can be introduced via the free end area of the hose. Additionally or alternatively, it is possible to form the connection device as a fluid distributor or the like. In such applications too, heating for instance a connection of the wiper blade or the fluid distributor by means of the heating device emitting heat in the heating operation as well as by means of the heated fluid is advantageous.

Preferably, the connection device, in particular end nozzle, is coupled to the free end area of the hose in fluid-tight manner. The tightness between the free end area and the connection device can be ensured by welding, in particular laser welding, and/or by means of an adhesive and/or by providing at least one sealing element, in particular in the form of an O-ring or the like.

It can be provided that the free end area of the hose is pushed onto a connection piece of the connection device in the assembly such that the free end area of the hose externally encompasses the connection piece. In this manner too, heating of the connection device by means of the hose emitting heat in the heating operation of the heating device is achievable.

Preferably, the free end area of the hose is inserted into a base body of the connection device, in particular of the end nozzle. Thus, it can be very simply caused in the heating operation of the heating device that the connection device, in particular the end nozzle, is also heated by means of the heating device of the hose. In this manner, it can be very efficiently prevented that freezing of fluid located in the connection device, in particular the end nozzle, occurs. Furthermore, the connection device, in particular the end nozzle, can be used as a heat store. Accordingly, a particularly fast heating of the fluid itself in the area of the connection device, in particular of the end nozzle, can be ensured in the operation of the hose.

These advantages apply to the connection device in analogous manner, which is arranged at the hose section of the hose, which is spaced from the respective end areas of the hose, such that the hose section passes through the connection device.

In order to achieve a good fixing of the end area of the hose inserted into the base body, the end area can be received in an insertion area of the base body with formation of a press fit. This is conducive to a simple and simultaneously safe connection of the connection device in particular formed as an end nozzle to the end area of the hose.

Preferably, the base body has an inner contour in the insertion area, which corresponds to a non-rotationally symmetrical outer contour of the hose. In this manner, it can be very simply ensured that the connection device in particular formed as an end nozzle is attached to the end area of the hose in a predetermined orientation when the end area of the hose is introduced or inserted into the insertion area of the base body. This is advantageous with regard to a simple and reliable assembly.

In order to achieve a good heat distribution in the connection device, a base body of the connection device can be formed of a heat conducting plastic. Such a heat conducting plastic can for example be provided by introducing metal particles and/or soot or the like into a plastic matrix.

Thus, a high thermal conductivity of the heat conducting plastic can be achieved, wherein by using a suitable amount of such substances, it is preferably caused that the plastic is thermally conductive, but not electrically conductive.

Preferably, at least one heat conducting body is arranged in the base body of the connection device, by means of which heat emitted by the hose in the heating operation of the heating device can be introduced into the base body of the connection device. By such a heat conducting body, a very good heat transfer from the hose into the connection device can be achieved. This is advantageous with respect to avoiding freezing of fluid located in the connection device.

For example, the heat conducting body can be formed of a material well conducting heat such as for instance aluminum and/or copper and/or an alloy containing aluminum and/or copper. In particular, upon producing the connection device in an injection molding method, such a heat conducting body or such heat conducting bodies can be very simply incorporated in the base body of the connection device.

Preferably, the at least one heat conducting body is directly in heat conducting contact with at least one of the electrodes. In this manner, heat is introduced into the heat conducting body via the heated metallic electrode and thus the connection device is heated. Thereby, a very efficient and extensive heating of the connection device can be achieved. This in particular applies if a plurality of heat conducting bodies is arranged in the base body, wherein a respective heat conducting body is in thermal contact with at least one respective electrode.

In particular, if the heat conducting body formed of the thermally conductive material is not electrically conductive, the heat conducting body can be in heat conducting contact with electrodes of different polarity. Furthermore, in particular with a thermally and electrically conductive heat conducting body, a plurality of electrodes of identical polarity can contact the heat conducting body and thus introduce heat into the heat conducting body in the heating operation.

The at least one heat conducting body can be formed in the manner of a sleeve, into which an end section of the electrode is introduced. Thus, a very good thermal contact of the heat conducting body can be achieved on the one hand. On the other hand, the electrode can be very simply introduced into the inherently rigid sleeve if the end area is inserted into the insertion area of the base body in assembling the connection device, in particular the end nozzle, to the end area of the hose.

In particular, it can be provided that the electrode formed in the manner of a braid is inserted into a first sleeve. This causes stiffening of a partial area of the electrode provided with the first sleeve. The first sleeve can in turn be inserted into a second sleeve, wherein a good connection of the two sleeves to each other can be effected in particular by a press fit and/or by clamping the first sleeve by means of the second sleeve, in particular due to deformation of the second sleeve. Thus, a very intensive thermally conducting or heat conducting contact is established between the electrode and the heat conducting bodies formed as sleeves.

In particular, a plurality of heat conducting bodies formed in the manner of a respective sleeve can be arranged in the base body of the connection device, in particular of the end nozzle, into which respective end sections of the respective electrodes are introduced. Thus, an intensive and very fast heating of the connection device, in particular of the end nozzle, is achievable.

Furthermore, it can be provided that the heat conducting body is in electrically conducting contact with electrodes of different polarity, wherein the heat conducting body is formed of a thermally and electrically conductive material. In such a case, an electrical current or heating current can flow across the electrodes and the heat conducting body in the heating operation, which can be used for heating the connection device in particular formed as the end nozzle. In the heating operation, such a heating current then flows parallel to the current, which flows through the electrically conductive plastic material in the heating operation. Therefore, a suitable dimensioning of the electrical resistance of the heat conducting body is to be kept in mind herein. In particular, the heat conducting body can also be provided by an electrically conductive plastic.

By providing the at least one heat conducting body, it can in particular be achieved that the connection device, in particular the end nozzle, can be heated up to at least one outlet, via which the fluid can exit the connection device, in particular the end nozzle, into the environment in the operation of the hose. The at least one outlet of the connection device, in particular of the end nozzle, can be formed as a radial outlet and/or as an axial outlet. Thus, according to purpose of employment of the nozzle, a purposeful supply of the area or surface with the heated fluid can be caused.

The hose arrangement according to the present disclosure includes a hose for heating a fluid, wherein the fluid is conveyable through a cavity of the hose. The hose includes a heating device with at least two electrodes, wherein the at least two electrodes are formed to input electrical energy into an electrically conductive plastic material of the heating device in a heating operation of the heating device. The heating device at least partially surrounds the cavity in circumferential direction. A connection device for outputting the fluid is arranged at the hose. Herein, a hose section of the hose, which is spaced from respective end areas of the hose, is passed through a receptacle of the connection device. The hose comprises at least one passage opening in the hose section, via which the fluid can be introduced into the connection device out of the cavity in lateral direction in the operation of the hose.

Accordingly, not only the fluid can be heated in the heating operation of the heating device, which is conveyed through the cavity. Rather, the connection device spaced from respective end areas of the hose is fluidically connected to the heated hose in simple and flexible manner.

Furthermore, the thermal heat emitted by the electrically conductive plastic material in the heating operation of the heating device can be additionally introduced into the connection device in the area of the receptacle of the connection device. Since the hose section is passed through the receptacle of the connection device or completely passes through the receptacle, this input of the thermal heat of the hose can be effected over the entire length of the receptacle. Accordingly, the connection device can also be heated by means of the hose in advantageous manner. Therefore, the hose arrangement is improved with regard to the heating operation.

Preferably, the connection device is in heat conducting contact with the hose section. This can be achieved in that the connection device is in abutment on an outer side of the hose section in the area of the receptacle at least in certain areas. Then, a very intensive heat transfer from the outer side of the hose section to the connection device can be effected in the heating operation of the heating device. A corresponding, very extensive heating of the connection device is advantageous.

In particular, the connection device can be formed to output that part of the fluid, which does not further flow through the cavity, into the environment of the hose arrangement. Accordingly, the connection device can be formed as an output element, in particular as a nozzle.

As the hose of the hose arrangement, the above described hose can in particular be employed, in which at least the heating device, in particular the entire hose including the heating device, has the contour or outer contour different from the rotationally symmetrical contour in cross-section, or an advantageous development of this hose. In particular, the non-rotationally symmetrical outer contour of the hose is advantageous with regard to a simple and positionally accurate attachment of the connection device to the hose section.

The advantages and preferred embodiments described for the hose according to the disclosure also apply to the hose arrangement according to the disclosure and vice versa.

The features and feature combinations mentioned above in the description as well as the features and feature combinations mentioned below in the description of figures and/or shown in the figures alone are usable not only in the respectively specified combination, but also in other combinations or alone without departing from the scope of the disclosure. Thus, implementations are also to be considered as encompassed and disclosed by the disclosure, which are not explicitly shown in the figures or explained, but arise from and can be generated by separated feature combinations from the explained implementations. Thus, implementations and feature combinations are also to be considered as disclosed, which do not comprise all of the features of an originally formulated independent claim. Moreover, implementations and feature combinations are to be regarded as disclosed, in particular by the implementations set forth above, which extend beyond or deviate from the feature combinations set forth in the relations of the claims.

### BRIEF DESCRIPTION OF THE SEVERAL VIEWS OF THE DRAWINGS

Further advantages, features and details of the disclosure are apparent from the claims, the following description of preferred embodiments as well as based on the drawings. There show:

FIG. 1 is in a schematic sectional view, a hose for heating a fluid, in which respective electrodes of the heating device are arranged in respective corner areas of an electrically conductive plastic material of a heating device;

FIG. 2 is a variant of the hose according to FIG. 1, in which the electrodes are formed ribbon-shaped;

FIG. 3 is in a schematic sectional view, the hose as well as a nozzle pushed onto the hose, which comprises an annular channel;

FIG. 4 is a further variant of the hose according to FIG. 1, in which the hose comprises positioning elements to preset a radial orientation of the nozzle that can be pushed onto the hose;

FIG. 5 is in a schematic longitudinal sectional view, the hose with the nozzle according to FIG. 3 as well as with a further nozzle, which is formed as an end nozzle;

FIG. 6 is schematically the coupling of an end area of the hose to the end nozzle, wherein electrodes of the hose are introduced into respective sleeves, which are arranged in a base body of the end nozzle;

FIG. 7 is a variant of the end nozzle according to FIG. 6, in which the end nozzle comprises a radial outlet; and

FIG. 8 is in a schematic sectional view, a variant of the hose, in which the hose has a closed U-shape in cross-section.

### DETAILED DESCRIPTION

In the figures, identical or functionally identical elements are provided with identical reference characters.

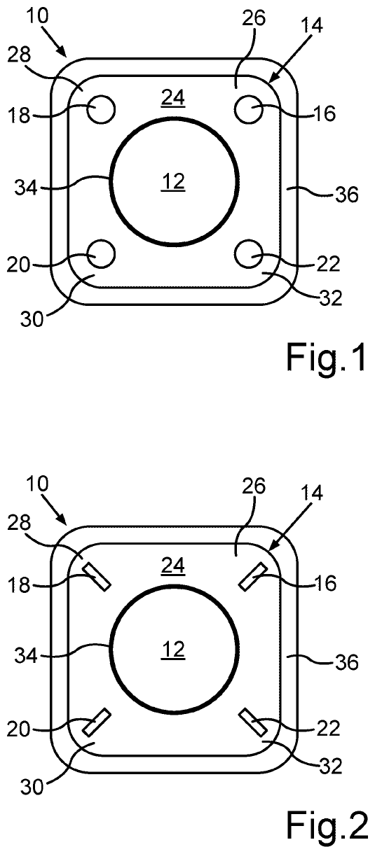

In FIG. 1, a hose 10 formed for heating a fluid is shown in a schematic cross-sectional view, which can therefore also be referred to as heating hose.

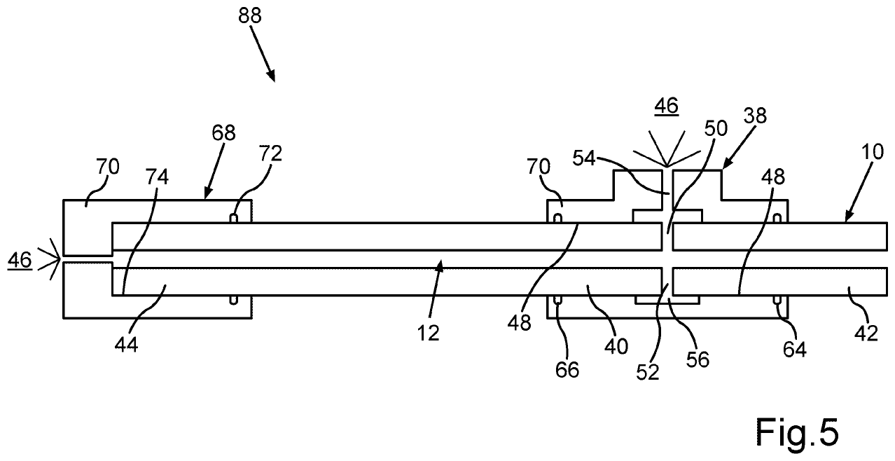

For example, the hose 10 or heating hose can be employed as a fluid line for a fluid such as for instance a washing liquid, with which a windshield or the like surface is for example to be supplied in a motor vehicle. In particular, if the windshield is formed as a front windshield of the motor vehicle or car, by supplying the windshield with heated washing liquid, it can be very extensively prevented that freezing of the washing liquid on the front windshield occurs at ambient temperatures below 0 °C. Additionally or alternatively, the front windshield can be freed from ice by means of the heated washing liquid. Thereby, good visibility conditions are ensured for a user of the motor vehicle looking through the front windshield. For this purpose, at least one connection device such as for instance a nozzle 38 (compare FIG. 5) and/or an end nozzle 68 (compare FIG. 5) and/or a wiper blade (not shown) and/or a fluid distributor (not shown) or the like can for example be connected to the hose 10.

Furthermore, the fluid can be employed as a washing liquid for supplying the surface of a field of view or capturing area of a sensor or the like device of the motor vehicle. In this respect too, it is advantageous if freezing of the fluid can be prevented or fast thawing of the fluid can be effected by heating of the fluid.

The hose 10 includes a cavity 12 or fluid channel or flow channel, which can be traversed by the fluid. Accordingly, the fluid can be conveyed through this cavity 12 of the hose 10, for instance if a windshield wiper system of the motor vehicle conveying the fluid is in operation.

Furthermore, the hose 10 comprises a heating device 14, which includes at least two electrodes 16, 18, 20, 22. The electrodes 16, 18, 20, 22 are formed to supply an electrically conductive plastic material 24 of the heating device 14 with electrical energy in a heating operation of the heating device 14 or to input the electrical energy into the electrically conductive plastic material 24 in a heating operation of the heating device 14.

The heating device 14 completely surrounds the cavity 12 presently having a round cross-section in the hose 10 exemplarily shown in FIG. 1 in circumferential direction. Accordingly, the cavity 12 is arranged within the electrically conductive plastic material 24 of the heating device 14.

In the hose 10, the electrically conductive plastic material 24 or the heating plastic preferably has a positive temperature coefficient (PTC). Thereby, the heating device 14 is inherently safe and the heating device 14 can be operated with high power without an undesirably high increase of a temperature of the hose 10 occurring in the heating operation.

With a given length of the hose 10, the heating power of the heating device 14 of the hose 10 can be increased by reducing the distance between the electrodes 16, 18, 20, 22 and/or by using multiple electrodes 16, 18, 20, 22. Accordingly, the heating device comprises exactly four electrodes 16, 18, 20, 22 in the variant exemplarily shown in FIG. 1.

In addition, at least the heating device 14 has a contour non-rotationally symmetrical, for example rectangular, in cross-section in the variant shown in FIG. 1. Accordingly, the four electrodes 16, 18, 20, 22 are arranged in respective corner areas of the heating device 14. For example, the first electrode 16 is arranged in a first corner area 26, the second electrode 18 is arranged in a second corner area 28, the third electrode 20 is arranged in a third corner area 30 and the fourth electrode 22 is arranged in a fourth corner area 32 of the heating device 14.

Herein, the first electrode 16 and the third electrode 20 can have a first electrical polarity, and the second electrode 18 as well as the fourth electrode 22 can have a second polarity deviating from the first polarity. Thereby, a current flow from one of the electrodes 16, 18, 20, 22 to the two electrodes 16, 18, 20, 22 adjacent in circumferential direction is effected in the operation of the heating device 14, in which a voltage is applied to the electrodes 16, 18, 20, 22. This causes the uniform heating of the fluid, which flows through the cavity 12.

Due to the rectangular contour of the heating device 14 as well as, according to FIG. 1, of the entire hose 10 with the four electrodes 16, 18, 20, 22, a very high electrical power of the heating device 14 is achieved in the heating operation with particularly low employment of electrically conductive plastic material 24.

In the variant shown in FIG. 1, the cavity 12 is circumferentially delimited by a lining 34, which is formed of an electrically insulating and/or chemically resistant material. Furthermore, the hose 10 presently comprises a sheathing or envelope 36, which causes high resistance of the hose 10 with regard to external influences on the one hand. On the other hand, an electrical insulation of the heating device 14 is achieved by the envelope 36 presently formed of an electrically insulating material.

The electrically conductive plastic material 24 can in particular comprise a copolymer as a plastic matrix. The copolymer can for example include a high-density polyethylene (HDPE) and a thermoplastic elastomer (TPE), in particular a thermoplastic elastomer containing styrene, thus a TPS.

For instance, such a HDPE/TPS copolymer can be formed as the plastic matrix, in which electrically conductive particles are embedded, to provide the electrically conductive plastic material 24. In particular, by admixing soot particles, the electrical conductivity can be imparted to the plastic material 24. Additionally or alternatively, the plastic matrix of the plastic material 24 can contain a metal powder or the like.

Furthermore, additionally or alternatively to the above-mentioned copolymer, the plastic matrix of the plastic material 24 can comprise a polybutylene terephthalate (PBT) and a thermoplastic elastomer (TPE), in particular a thermoplastic copolyester elastomer (TPE-E), and thus be formed for instance as a PBT/TPE-E copolymer. As the plastic matrix of the electrically conductive plastic material 24, however, another suitable polymer than the above exemplarily mentioned copolymers can also be employed.

According to FIG. 1, the envelope 36 surrounds the heating device 14 having the rectangular contour in cross-section with an at least substantially constant thickness, such that the entire hose 10 has the rectangular contour in cross-section. In variants not shown in more detail, at least the heating device 14 or also the entire hose 10 including the heating device 14 can have a different than the rectangular contour.

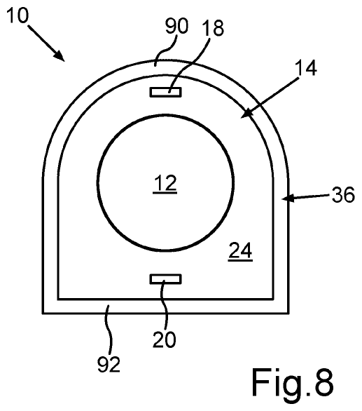

In the variants of the hose shown in FIG. 1 and in FIG. 8, a respective outer contour of the hose 10 is non-rotationally symmetrical or different from a rotationally symmetrical contour. This is due to the fact that the envelope 36 has a substantially constant thickness. Therefore, the contour of the heating device 14 non-rotationally symmetrical in cross-section becomes noticeable in a corresponding contour or outer contour of the entire hose 10.

In a variant (not shown) of the hose, it can be provided that the envelope 36 has a different thickness along its circumference or in circumferential direction. This allows configuring the contour of the electrically conductive plastic material 24 independently of the contour or outer contour of the entire hose 10 or heating hose including the envelope 36.

The variant of the hose 10 shown in FIG. 2 very largely corresponds to the variant shown in FIG. 1. However, the four electrodes 16, 18, 20, 22, which are arranged in the four corner areas 26, 28, 30, 32 of the heating device 14, are here formed ribbon-shaped. Thereby, a large contact surface of the respective electrode 16, 18, 20, 22 with the conductive plastic material 24 is provided, in which the electrodes 16, 18, 20, 22 are embedded.

In particular, the hose 10 can be produced in an extrusion method, in which the electrodes 16, 18, 20, 22 are arranged in a corresponding extrusion plant during the manufacturing process such that they are embedded in the plastic material 24 in extruding. This has the advantage that an additional manufacturing step for providing the heating device 14 is not required.

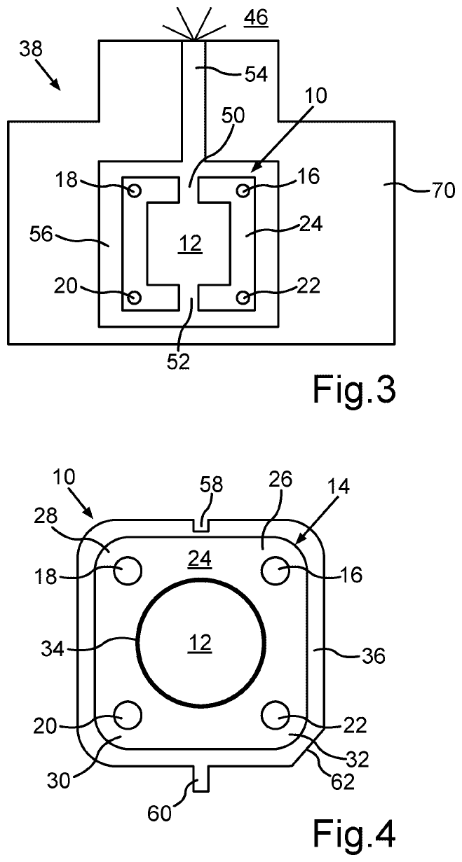

The contour of the heating device 14 or of the hose 10 rectangular in cross-section is advantageous not only with regard to the high heating power using comparatively little of the conductive plastic material 24, but also with regard to the attachment of at least one nozzle 38 to the hose 10. This is to be explained with reference to FIG. 3, FIG. 4 and FIG. 5.

Namely, the at least one nozzle 38 is preferably arranged at the hose 10, namely in a hose section 40, which is spaced from respective end areas 42, 44 of the hose 10 (compare FIG. 5).

The nozzle 38 shown in a schematic cross-sectional view in FIG. 3 and in a schematic longitudinal section in FIG. 5 allows discharging the fluid flowing through the cavity 12 in the operation of the hose 10 in an area spaced from the end areas 42, 44, namely in the hose section 40, into an environment 46 of the hose 10 or conveying it out of the cavity 12. Herein, the nozzle 38 spaced from the end areas 42, 44 can be very simply pushed onto the hose 10.

Due to the outer contour of the hose 10 non-rotationally symmetrical in cross-section, namely, a rotation of the nozzle 38 around the hose 10 is avoided. In other words, the nozzle 38 is secured against rotation, and a desired radial orientation of the nozzle 38 can be very simply achieved in pushing the nozzle 38 onto the hose 10.

In particular, it is apparent from FIG. 5 in this respect that the nozzle 38 preferably comprises a receptacle 48 with an inner contour for this purpose, which corresponds to the outer contour of the hose 10. With the outer contour of the hose 10 rectangular or substantially square in cross-section exemplarily shown in FIG. 1 and FIG. 2, thus, the inner contour of the receptacle 48 can be formed in rectangular or substantially square manner.

In order that the fluid can get from the cavity 12 into the nozzle 38 and further into the environment 46 via the nozzle 38, the hose 10 according to FIG. 3 and according to FIG. 5 comprises at least one passage opening 50, 52, via which the fluid is conveyable in lateral direction out of the cavity 12 in the operation of the hose 10. In the variant exemplarily shown in FIG. 3 and FIG. 5, not only a first passage opening 50 is provided, which is preferably aligned with an outlet channel 54 formed in the nozzle 38. Rather, two passage openings 50, 52 are formed in the hose 10, which are arranged aligned with each other, presently aligned with each other in radial direction. In the operation of the hose 10, the fluid can get into an annular channel 56 of the nozzle 38, which is in turn in fluidic communication with the outlet channel 54 of the nozzle 38, via these two passage openings 50, 52.

The passage openings 50, 52 arranged aligned with each other in radial direction can be very simply generated in one production step or working step, for instance by separating respective areas out of the hose 10 by punching and/or drilling and/or cutting, in particular laser cutting, or the like. If the two passage openings 50, 52 are produced in the hose 10, before the nozzle 38 is pushed onto the hose 10, it can be particularly simply prevented that residuals of hose material remain in the cavity 12.

In addition, the two passage openings 50, 52 can each have comparatively small cross-sections capable of being traversed, and comparatively much fluid can still be conveyed into the environment 46 via the outlet channel 54. This is in particular advantageous with regard to the fact that an impairment or damage of the electrodes 16, 18, 20, 22 can be particularly simply and particularly extensively avoided in producing the two respectively comparatively small passage openings 50, 52. Accordingly, a punching tool and/or cutting tool and/or laser tool can be very simply positioned such that it is arranged, for example, both between the electrodes 16, 18 adjacent to each other and between the electrodes 20, 22 adjacent to each other.

In order to ensure exactly one predetermined radial orientation of the nozzle 38 in pushing the same onto the hose 10, the hose 10 can comprise at least one positioning element, wherein the nozzle 38 comprises a structural element corresponding to the positioning element. As an example for such positioning elements, an indentation 58 or groove or notch and a bulge 60 formed in the manner of a pin-shaped projection as well as a chamfer 62 are schematically shown in FIG. 4.

As is apparent from FIG. 4, such positioning elements can in particular be formed in the envelope 36 of the hose 10. Then, the geometry of the heating device 14 advantageously remains particularly unimpaired by such positioning elements. For the rest, the variant of the hose 10 shown in FIG. 4 substantially corresponds to the variant of the hose 10 shown in FIG. 1.

In FIG. 3 and FIG. 5, only one nozzle 38 spaced from the end areas 42, 44 is shown. However, multiple such nozzles 38 can also be attached to the hose 10. It is apparent from FIG. 5 that sealing elements for instance in the form of sealing rings 64, 66 can be provided for sealing the nozzle 38 with respect to the hose 10. Additionally or alternatively, the nozzle 38 can be attached to the hose 10 in fluid-tight manner in the hose section 40 by means of an adhesive, by welding, in particular laser welding, by molding or the like.

The heating device 14 of the hose 10 can have a heating power of about 2.5 W/m² at room temperature. Furthermore, the heating device 14 is preferably designed for applying a low voltage in the range of for example 13.5 V to maximally 50 V. This is advantageous with regard to simply ensuring electrical safety of the heating device 14.

In FIG. 5, a hose arrangement 88 is shown, which includes the hose 10 and at least one connection device for instance in the form of the nozzle 38, which is arranged at the hose 10 spaced from the end areas 42, 44. In advantageous manner, this connection device is heated by the fluid, which flows through the connection device in the form of the nozzle 38 in the hose section 40, in the heating operation of the heating device 14.

It is further apparent from FIG. 5 that an end nozzle 68 can be arranged at the hose 10 additionally or alternatively to the nozzle 38 spaced from the end areas 42, 44. The nozzle 38 and/or the end nozzle 68 can in particular be formed of plastic, for example of polyoxymethylene (POM) and/or polybutylene terephthalate (PBT). The fluid can also be output into the environment 46 of the hose 10 via the end nozzle 68.

A free end area 44 of the hose can be inserted into a base body 70 of the end nozzle 68 with formation of a press fit (compare FIG. 5). Furthermore, the tightness between the end nozzle 68 and the inserted hose 10 can be ensured by welding, in particular laser welding, and/or glueing. Additionally or alternatively, the fluid-tight coupling of the end nozzle 68 to the free end area 44 of the hose 10 can be ensured by means of a sealing element in the form of a sealing ring 72 (compare FIG. 5).

According to FIG. 5, one of the end areas 42, 44 of the hose 10, namely the free end area 44, is attached to the base body 70 and preferably inserted into the base body 70 of the end nozzle 68. In this manner, the end nozzle 68 can also be very well heated by means of the hose 10.

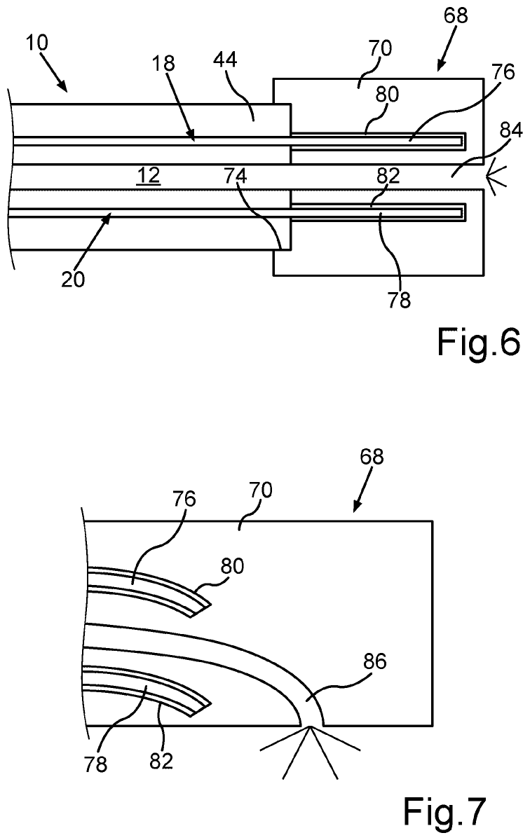

Based on FIG. 6 and FIG. 7, a further possibility of heating the end nozzle 68 is to be explained. In the variant of the hose 10 shown in FIG. 6 too, the base body 70 comprises an insertion area 74 with an inner contour (analogously to the representation of the end nozzle 68 fitted onto the free end area 44 of the hose 10 schematically shown in FIG. 5), which corresponds to the outer contour of the hose 10.

However, in the variant of the hose 10 shown in FIG. 6, end sections 76, 78 of two of the electrodes 16, 18, 20, 22 protrude beyond the free end area 44 of the hose 10 into the base body 70 of the end nozzle 68. Accordingly, these free end sections 76, 78 are not sheathed by the electrically conductive plastic material 24. According to FIG. 6, depressions can be formed in the base body 70, into which the end sections 76, 78 of at least two of the electrodes 16, 18, 20, 22 are introduced.

For example, the end section 76 can be associated with the first electrode 18 and the end section 78 can be associated with the second electrode 20. Heat can be input into the end nozzle 68 via these end sections 76, 78 of the electrodes 18, 20. For this purpose, heat conducting bodies 80, 82 can be arranged in the base body 70 of the end nozzle 68, which are in thermally conducting contact with each one of the end sections 76, 78.

For example, the first heat conducting body 80 can be in thermally conducting contact with the first end section 76 and the second heat conducting body 82 can be in thermally conducting contact with the second end section 78. In analogous manner, the two further electrodes 16, 22 not shown in FIG. 6 for reasons of simplicity can be in thermally conducting contact with corresponding heat conducting bodies of the end nozzle 68.

The heat conducting bodies 80, 82 can be formed in the manner of sleeves closed on the end side and/or sleeves or tubes open on the end side, into which the end sections 76, 78 of the respective electrode 18, 20 are introduced. Thus, the end nozzle 68 can be very simply and efficiently heated.

For example, the sleeve-like or tubular heat conducting bodies 80, 82 can be formed of a thermally well conductive material such as for example aluminum and/or copper or of an alloy containing aluminum and/or copper.

In order to ensure a good thermal conductivity within the end nozzle 68, the base body 70 can additionally or alternatively be formed of a heat conducting plastic. For example, a plastic matrix of the base body 70 can be mixed with metal particles and/or with soot to ensure a good thermal conductivity of the base body 70.

As described for the end nozzle 68, the base body 70 of the nozzle 38 shown in FIG. 3 and FIG. 5 can also be formed of a heat conducting plastic. Thereby, very good heating of the nozzle 38 can be achieved in the heating operation of the heating device 14.

Furthermore, at least one heat conducting body can also be arranged in the base body 70 of the nozzle 38, as it is presently described with reference to the end nozzle 68.

In particular, in the variant of the hose 10 shown in FIG. 6, an electrically conducting connection (not illustrated in the sectional view) between the two heat conducting bodies 80, 82 can be provided. For example, the electrically conducting connection can be formed by a sleeve of metal or an electrically conductive plastic surrounding or enveloping the cavity 12. The current or heating current flowing through the electrodes 16, 18, 20, 22 in the operation of the heating device 14 then flows parallel also across this sleeve. This heating current can be used for specifically heating the end nozzle 68. Here, by suitable adjustment of an electrical resistance of the sleeve or the electrically conducting connection, it can be caused that both the area of the hose 10 comprising the electrically conductive plastic 24 and the end nozzle 68 are sufficiently heated.

In the variant of the hose 10 shown in FIG. 6, the end nozzle 68 comprises an axial outlet 84. In contrast, a radial outlet 86 is provided in the end nozzle 68 schematically shown in FIG. 7. However, in FIG. 7 too, the end sections 76, 78 of the electrodes 18, 20 introduced into the heat conducting bodies 80, 82 formed in the manner of sleeves or tubes are indicated, which reach into the base body 70 of the end nozzle 68.

If the electrodes 20, 18 have a great inherent rigidity, for example by formation of the respective electrodes 18, 20 as respectively massive wires or the like, the introduction of the electrodes 18, 20 into the heat conducting bodies 80, 82 formed in the manner of sleeves or tubes according to FIG. 6 becomes comparatively simple.

In particular, if the electrodes 18, 20 are formed as braids with a plurality of preferably twisted individual wires in contrast thereto, end areas of these braids can be introduced into a respective first sleeve (not shown) and attached therein before introducing into the end nozzle 68. The attachment of the end areas of the respective braid in the respective first sleeve can for example be achieved by crimping. The first sleeves then serve for stiffening the end areas of the respective braid. Accordingly, these stiffened end areas can then be easier introduced into the end nozzle 68, in particular into the heat conducting bodies 80, 82 arranged in the base body 70 of the end nozzle 68.

In FIG. 8, a further variant of the heating device 14 having the non-rotationally symmetrical contour or of the hose 10 having the non-rotationally symmetrical outer contour is shown in a sectional view. Accordingly, the heating device 14 can have a closed U-shape in cross-section. Furthermore, the outer contour of the hose 10 can be such a circumferentially closed U-shape. Here, only the two electrodes 18, 20 are exemplarily shown, which can be formed ribbon-shaped as in the variant according to FIG. 2.

In the arrangement shown in FIG. 8, the upper electrode 18 in FIG. 8 is close to a curved wall area 90 of the envelope 36. In contrast, the lower electrode 20 in FIG. 8 is close to a substantially flat wall area 92 of the envelope 36, which is opposing the curved wall area 90.

In a manner presently not shown in more detail, the electrodes 18, 20 can also be arranged in respective corner areas of the hose 10 having a closed U-shape in cross-section.

In order to connect the electrodes 16, 18, 20, 22 of the hose 10 to a voltage source (not shown), cutting claws or cutting clamps presently not shown for reasons of clarity can be attached to the hose 10. Such cutting claws or cutting clamps cut through the envelope 36 and the plastic material 24 in attaching to the hose 10 until they come into contact with the respective electrode 16, 18, 20, 22.

By the use of such cutting claws, by which contact elements of the hose 10 for connecting the hose 10 to the voltage source are provided, the electrical contact of the electrodes 16, 18, 20, 22 can be achieved with very low effort, namely without the electrodes 16, 18, 20, 22 having to be exposed.

With respect to the positioning or attachment of the cutting clamps or cutting claws, it is also advantageous that the hose 10 or heating hose has the contour or outer contour non-rotationally symmetrical in cross-section because thereby the cutting claws or cutting clamps can be uniquely and simply positioned.

Additionally or alternatively to the use of cutting claws, it is possible to connect the electrodes 16, 18, 20, 22 to corresponding contact elements by welding and/or crimping, via which the electrodes 16, 18, 20, 22 can be connected to the voltage source (not shown).

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A hose for heating a fluid, comprising:
a cavity through which the fluid is conveyable; and
a heating device which includes at least two electrodes configured to input electrical energy into an electrically conductive plastic material of the heating device in a heating operation of the heating device,
wherein the heating device at least partially surrounds the cavity in a circumferential direction, and
wherein at least the heating device has a contour in cross-section, that is different from a rotationally symmetrical contour.

2. The hose according to claim 1,
wherein at least the heating device has a contour rectangular in cross-section, and wherein a respective electrode is arranged in four corner areas of the heating device.

3. The hose according to claim 1,
wherein the electrodes are arranged symmetrically in the plastic material with respect to at least one plane of symmetry which includes a central axis of the hose.

4. The hose according to claim 1,
wherein the hose comprises at least one passage opening via which the fluid is conveyable out of the cavity into an environment of the hose in the operation of the hose.

5. The hose according to claim 4,
wherein at a hose section of the hose which is spaced from respective end areas of the hose at least one connection device configured for outputting the fluid is arranged, wherein the fluid is introduced into the connection device via the at least one passage opening in the operation of the hose and wherein the connection device comprises a receptacle with an inner contour which corresponds to a non-rotationally symmetrical outer contour of the hose.

6. The hose according to claim 5,
wherein the at least one passage opening comprises two passage openings arranged aligned with each other, and
wherein the connection device comprises an annular channel, via which the fluid is introduced into the connection device from the two passage openings.

7. The hose according to claim 5,
wherein the hose comprises at least one positioning element by way of which the connection device is arranged at the hose section in a predetermined radial orientation and secured against rotation, wherein the connection device comprises a structural element corresponding to the positioning element.

8. The hose according to claim 7,
wherein the at least one positioning element is provided by an indentation and/or bulge and/or chamfer formed at least in an envelope of the hose, wherein the envelope of the hose externally encompasses the heating device.

9. The hose according to claim 1,
wherein at a free end area of the hose a connection device for outputting the fluid, in particular coupled to the free end area in fluid-tight manner, in particular an end nozzle formed for outputting the fluid into the environment is arranged, wherein the free end area is inserted into a base body of the connection device, and wherein the base body comprises an insertion area with an inner contour which corresponds to a non-rotationally symmetrical outer contour of the hose.

10. The hose according to claim 4,
wherein, in a base body of the connection device at least one heat conducting body is arranged by way of which heat emitted by the hose is introduced into the base body of the connection device in the heating operation of the heating device.

11. The hose according to claim 10,
wherein the at least one heat conducting body comprises a thermally conductive material, that is in heat conducting contact with at least one of the electrodes.

12. A hose arrangement comprising:
a hose for heating a fluid, wherein the fluid is conveyable through a cavity of the hose, wherein the hose includes a heating device with at least two electrodes configured to input electrical energy into an electrically conductive plastic material of the heating device in a heating operation of the heating device, wherein the heating device at least partially surrounds the cavity in a circumferential direction, and
a connection device arranged at the hose for outputting the fluid,
wherein a hose section of the hose, which is spaced from respective end areas of the hose, is passed through a receptacle of the connection device,
wherein the hose comprises at least one passage opening in the hose section via which the fluid is introduced into the connection device in a lateral direction out of the cavity in the operation of the hose.

13. The hose arrangement according to claim 12, wherein at least the heating device has a contour in cross-section that is different from a rotationally symmetrical contour.

14. The hose according to claim 3, wherein the electrodes are ribbon shaped.

15. The hose according to claim 4, wherein the at least one passage opening has a round cross-section in a lateral direction.

16. The hose according to claim 5, wherein the connection device is a nozzle configured to output the fluid into the environment.

17. The hose according to claim 7, wherein the connection device is connected to the hose section in a fluid-tight manner.

18. The hose according to claim 9, wherein the connection device is an end nozzle coupled to the free end area in fluid-tight manner for outputting the fluid into the environment.

19. The hose according to claim 10, wherein the base body of the connection device comprises a heat conducting plastic.

20. The hose according to claim 11, wherein the at least one heat conducting body is a sleeve into which an end section of the electrode is introduced.
